(19) United States
(12) Patent Application Publication
(10) Pub. No.: US 2010/0161172 A1
(43) Pub. Date: Jun. 24, 2010

(54) SYSTEM AND METHOD FOR MANAGING A VEHICLE COMPONENT USING TEMPORARY ON-BOARD DATA STORAGE

(75) Inventor: Kristina Bjelkstål, Molndal (SE)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/640,485

(22) Filed: Dec. 17, 2009

(30) Foreign Application Priority Data
Dec. 18, 2008 (EP) 08021974.4

(51) Int. Cl. G06F 7/00; G01M 17/00; G06F 17/30

(52) U.S. Cl. 701/33; 707/802; 707/E17.044

(57) ABSTRACT

A system for managing a vehicle component includes a controller executing a task, at least one of a receiver and a transmitter for transmitting data to/from an off-board communication unit, and a memory. The memory temporarily stores at least a portion of the data received from or transmitted to the communication unit and subsequently deletes at least some of the data the controller has completed executing the task and/or communication with the external communication unit is complete. A method for managing a component of a vehicle using temporary storage in on-board memory is also disclosed.

### CROSS-REFERENCE TO RELATED APPLICATIONS

This application claims foreign priority benefits under 35 U.S.C. §119(a)-(d) to EP 08021974.4 filed Dec. 18, 2008, which is hereby incorporated by reference in its entirety.

### BACKGROUND

1. Technical Field

The present invention concerns a system and method for communicating with off-board monitoring equipment to manage the operation of components of a vehicle.

2. Background Art

An electronic control unit (ECU) (also known as an electronic control module) is an embedded system that controls one or more of the electrical systems or subsystems in a vehicle. ECUs can for example be arranged to monitor a vehicle's engine, transmission, traction, anti-lock braking system, airbags, doors or seats. An ECU can be arranged to gather data, such as a vehicle's coolant temperature or the amount of a particular gas in the vehicle's exhaust, from a plurality of different sensors and to perform millions of calculations each second using the data it acquires, including looking up values in tables and solving equations, in order to determine optimum operating conditions to ensure the lowest emissions and best mileage for example.

An ECU can be arranged to store information, such as information concerning faults with a specific component/system. This information can be retrieved from the ECU, by means of connecting an external tester to the on-board diagnostics (OBD) contacts in a vehicle when the vehicle is taken to be repaired/serviced. This can make it easier for a mechanic to diagnose problems with the vehicle, especially intermittent problems, which have a tendency to disappear as soon as the vehicle is taken to be repaired/serviced.

A modern passenger car today can however contain up to one hundred ECUs and a single ECU can contain multiple micro-processors. As the number and complexity of ECU's in vehicles increase, the vehicles' electrical systems will require more processing power and more computer data storage space in order to execute tasks and store data.

U.S. Pat. No. 7,184,866 discloses a system comprising a vehicle and an off-board computer system. The vehicle includes an on-board computer system that is capable of performing diagnostic tests to assess the vehicle's operational readiness and diagnose vehicle malfunctions. The on-board computer system is arranged to store information that it collects from a plurality of input devices and is arranged and to transmit at least some of the stored information by way of a wireless radio-frequency communication link to the off-board computer system. Such a system will increase a vehicle's processing power requirements and computer data storage space requirements, since the on-board computer system will not only need to store information from a plurality of input devices, but also transmit at least part of the stored information to an off-board computer.

### SUMMARY

An object of the invention is to overcome or ameliorate at least one of the disadvantages of the prior art, or to provide a useful alternative. A further object of the present invention is to provide an improved system for managing at least one component of a vehicle in which it is mounted.

The expression “managing at least one component of a vehicle” as used in this document is intended to mean to monitor, keep track of, and/or check/test a vehicle component to ensure that it is functioning correctly, perform programming, such as ECU programming, and/or to collect data concerning the status/performance of the vehicle or one or more vehicle components. It should be noted that “a component of a vehicle” as used in this document is intended to mean a hardware or a software component of a vehicle.

At least one of these objects is achieved by a device arranged to manage at least one component of a vehicle The device comprises a controller that is arranged to execute at least one of the following tasks: collect data, download software or script, carry out a measurement, and perform a test, programming and/or diagnostics on at least one component of the vehicle. The device optionally comprises a receiver that is arranged to receive incoming data associated with at least one of the tasks from an external communication unit that is remote to the vehicle, such as an off-board computer or a system comprising components such as a database, a queue handler, a user portal and/or a user interface etc. Alternatively or additionally to the receiver the device comprises a transmitter that is arranged to transmit outgoing data to an external communication unit. The device also comprises a memory that is arranged to only temporarily store any incoming and/or outgoing data associated with at least one of the tasks so as to minimize the amount of data storage capacity required in the vehicle.

The expression “only temporarily store the incoming and/or outgoing data associated with at least one of the tasks” as used in this document is intended to mean that the device comprises means to delete outgoing data associated with at least one of the tasks executed by its controller from its memory substantially as soon as they have been transmitted to an external communication unit or, optionally, on receipt of confirmation that the outgoing data have been received by an external communication unit. Additionally, or alternatively the device comprises means to delete incoming data associated with at least one of the tasks from its memory substantially as soon as its controller has executed the task(s) and/or as soon as the controller has been sent a command to abort a task. Data are not therefore statically/permanently stored in the device itself. They are only temporarily stored in the device while they are needed to execute a particular task until the task has been completed and any data/commands generated during the execution of the task have been sent.

Such a system can be used to perform diagnostics, measurements and to program itself to execute certain tasks. Tasks may be carried out on the system itself or on an ECU or a component/function connected via the vehicle's busses. Tests/checks and programming may consequently be carried out on different vehicles/vehicle components without a user having to take a vehicle to a workshop. Instead, tests/checks are carried out while the vehicle is in operation or parked in a user's garage for example. It should be noted that diagnostics measurements and programming may be arranged to be performed only after a user has given his/her approval and optionally only when a vehicle is not being used and is locked and its alarm is turned on. As soon as the results of the tests have been analysed, vehicle components that will need to be replaced can be ordered in advance, thus limiting the amount of time a vehicle is out of service. Furthermore, since all data is stored and analyzed remotely from a vehicle, the utilization of a system according to the present invention can decrease the processing power and computer data storage space required to support monitoring of the vehicle without compromising the complexity or efficiency of the vehicle's monitoring systems. A system according to the present invention may also be used to detect trends in, and defects and faults from, the data being sent to an external communication unit from a plurality of vehicles.

It should be noted that a device according to the present invention may solely consist of software components. Software components which constitute the device may be provided in an existing ECU in a vehicle. The device may however comprise both software and hardware components.

Furthermore, the device according to the present invention itself need not necessarily comprise a receiver, transmitter or a memory. A receiver, transmitter or memory may be provided elsewhere in the vehicle and merely be arranged to communicate with the other components of the device. The device according to the present invention may at least partly utilize at least part of the memory of one or more ECUs in the vehicle for example.

According to an embodiment of the invention the controller is arranged to execute a task only if/when a particular condition, such as a particular vehicle operating condition, such as if/when the vehicle's handbrake is applied, or a date or time, is met. A controller may be arranged to prioritise a certain task (if the task is defined as being urgent in the commands received from an external communication unit for example). The controller may be arranged to arrange tasks in a queue for execution in order of priority. Each task may contain an “execute by . . . ” indication such as a time and/or date by which the task should be initiated or completed, and/or an indication that specifies that a certain condition should be met before the a particular task is executed. The device may be arranged to inform an external communication unit that a task has not been completed/initiated by a certain time/date or when a particular condition was met and optionally to delete the task from its memory without executing the task.

According to a further embodiment of the invention the controller is arranged to execute a task only on receipt of a command to do so from the external communication unit and/or from a user of the vehicle. The device may for example comprise input means such as a keypad, touch screen or microphone to allow a user to provide such a command. An input means may also be used to allow a user to request/approve that certain data/commands are downloaded from an external communication unit or to send data/commands to the external communication unit. A user of the external communication unit may for example request that a particular test is carried out (optionally on a particular date and/or a particular time), or that a particular component is ordered.

According to an embodiment of the invention the system is arranged to send a message to the user of a vehicle to inform him/her of when his/her vehicle needs to be brought in for service and/or to inform him/her that his/her vehicle or a vehicle component thereof is the subject of a software update/ECU programming and/or to ask the user to approve that the system performs a programming or diagnostics task and/or inform the user that the system is performing a programming or diagnostics task.

The present invention also concerns a vehicle, such as a car, truck, heavy goods vehicle or bus, which comprises a device according to any of the embodiments of the invention. The device may form an integral part of the vehicle or may be removably mounted therein.

The present invention further concerns a system for monitoring and managing at least one component of at least one vehicle, which comprises at least one device according to any of the embodiments of the invention and an external communication unit that is arranged to send data associated with at least one of the tasks that are to be executed by the system's controller to the at least one device/vehicle. Additionally or alternatively, the system is arranged to receive data associated with at least one of the tasks from the at least one device/vehicle. Such a system may be used to test and/or program one or more parts of each of a plurality of vehicles, such a selected population of passenger cars, substantially simultaneously.

According to an embodiment of the invention the device is arranged to interrupt its internal communication, via the vehicle's busses for example, i.e. to be overridden, if an external tester is connected (wirelessly or in a wired manner) to the vehicle, via the vehicle's on-board diagnostics (OBD) contacts for example. Alternatively, the device may be arranged to continue to function while an external tester is connected to the on-board diagnostics (OBD) contacts in a vehicle and is carrying out tasks. The external tester may furthermore be arranged to program the device.

The present invention also concerns a method for monitoring at least one component of at least one vehicle. The method comprises the steps of: executing at least one of the following tasks: collecting data, downloading software, carrying out a measurement, performing a test and/or diagnostics on at least one component of the vehicle, and only temporarily storing any incoming and/or outgoing data associated with execution of the task(s) in the device's memory. The method therefore comprises the step of deleting incoming data associated with at least one of the tasks from the memory substantially as soon as a task has been executed and/or substantially as soon as outgoing data have been transmitted to the external communication unit, optionally on receipt of confirmation that the external communication unit has received the outgoing data. Incoming data may however be stored if a task is to be repeated, such as if a fault detection task is to be carried out several times a week.

According to an embodiment of the invention the task execution step is carried out only if/when a particular condition is met. This embodiment of the method does not necessarily require only temporarily storing any incoming and/or outgoing data associated with task execution in the device's memory.

According to a further embodiment of the invention the method comprises the step of causing the controller to execute at least one task by sending a command from the external communication unit or from a user of the vehicle to the receiver.

The present invention further concerns a computer program product that comprises a computer program containing computer program code means arranged to cause a computer or a processor to execute the steps of a method according to any of the embodiments of the invention, stored on a computer-readable medium or a carrier wave.

### BRIEF DESCRIPTION OF THE DRAWINGS

The present invention will hereinafter be further explained by means of non-limiting examples with reference to the appended schematic figures where;

FIG. 1 shows a system according to an embodiment of the invention;

FIG. 2 shows the components of a system according to an embodiment of the invention;

FIG. 3 is a flow diagram showing the steps of a method according to an embodiment of the invention.

It should be noted that the drawings have not been drawn to scale and that the dimensions of certain features have been exaggerated for the sake of clarity.

### DETAILED DESCRIPTION

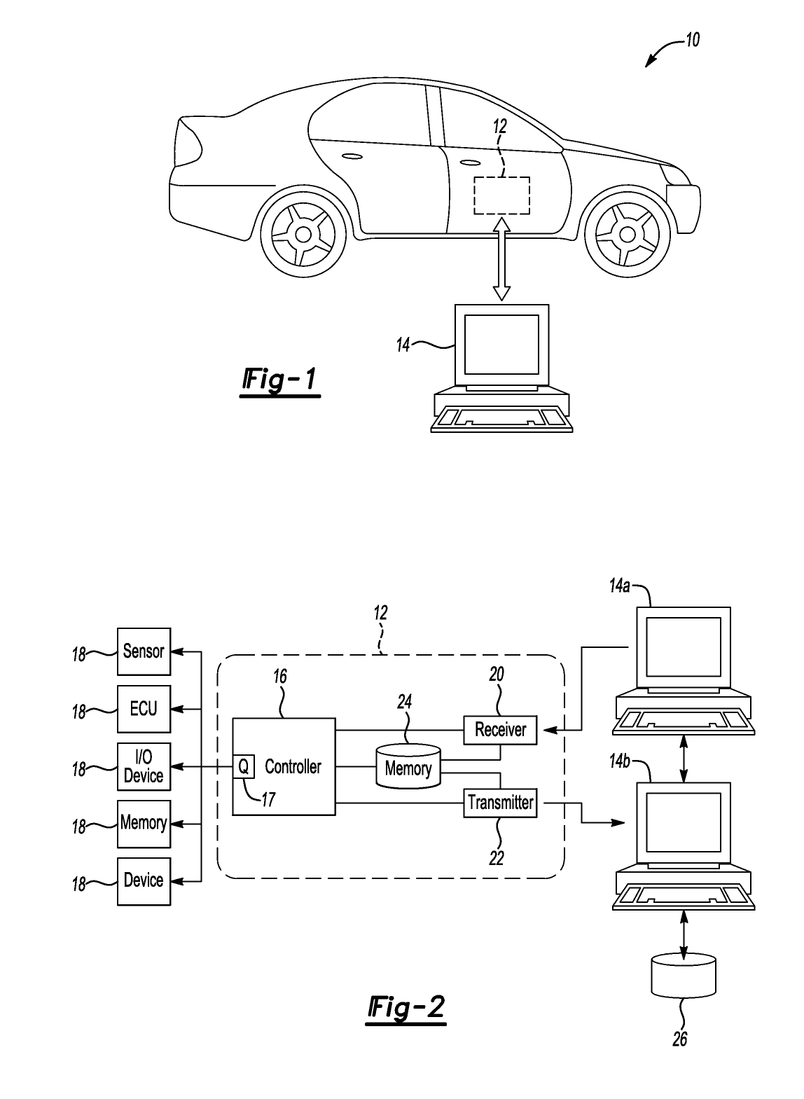

FIG. 1 shows a system according to an embodiment of the invention. The system comprises a vehicle 10, namely a passenger car in the illustrated embodiment, in which an internal device 12 has been mounted. An external communication unit 14 is arranged to send data associated with at least one of the tasks that the controller of the device 12 executes to the device 12 and/or to receive data associated with the at least one of the task from the device 12 via a wireless radio frequency communication link. It should be noted that the device 12 may be mounted anywhere in the vehicle 10, such as in one of the vehicle's ECUs, and that it may be constituted by a plurality of separate parts mounted in the same location or at different locations in the vehicle 10. A vehicle 10 may furthermore comprise a plurality of devices 12 according to the present invention. The term data as used herein is understood to include any and all software, instructions, commands, or other information associated with a task related to any vehicle component or system.

FIG. 2 shows the device 12 that is mounted in the vehicle 10 illustrated in FIG. 1. The device 12 comprises a controller 16 that is arranged to execute at least one of the following tasks: collect data from a plurality of devices 18 such as sensors, ECUs, input-output devices, or any other equipment distributed throughout the vehicle 10. The controller 16 is arranged to download software and/or data from a first external communication unit 14a that is remote to the vehicle 10, carry out a measurement, perform a test, programming and/or diagnostics on at least one component of the vehicle 10 using equipment 18 distributed throughout the vehicle 10 to monitor a vehicle's engine, transmission system, traction, anti-lock braking system, airbags, doors or seats for example and/or to manage any tasks related thereto, such as programming an ECU or detecting a fault. The device may optionally comprise a queue handler 17 to prioritize the order in which tasks are executed.

The device 12 also comprises a receiver 20 that is arranged to wirelessly receive incoming data associated with at least one of the tasks executed by the controller 16 from the first external communication unit 14a. The device 12 also comprises a transmitter 22 that is arranged to wirelessly transmit outgoing data to a second external communication unit 14b. The controller 16, the memory 24, the receiver 20 and the transmitter 22 may be interconnected by wireless or wired means, such as via internal buses although it should be noted that all of these components are mounted on the vehicle 10. It should be noted that the receiver 20 and transceiver 22 could of course be combined in a single transceiver.

In the illustrated embodiment incoming data are received from a first external communication unit 14a and outgoing data are sent to a second external communication unit 14b. Incoming and outgoing data may however be sent to and/or from any number of external communication units 14. If a system comprises a plurality of external communication units 14a, 14b, the external communication units 14a, 14b may of course communicate with one another. A first external communication unit 14a may for example be responsible for ordering spare parts once test results have been analyzed by a second external communication unit 14b. The second communication unit 14 may also be arranged to permanently store all test results in one or more external databases 26.

The device 12 also comprises a memory 24 that is arranged to only temporarily store the incoming and/or outgoing data associated with at least one of the tasks so as to minimize the amount of data storage capacity required in the vehicle 10.

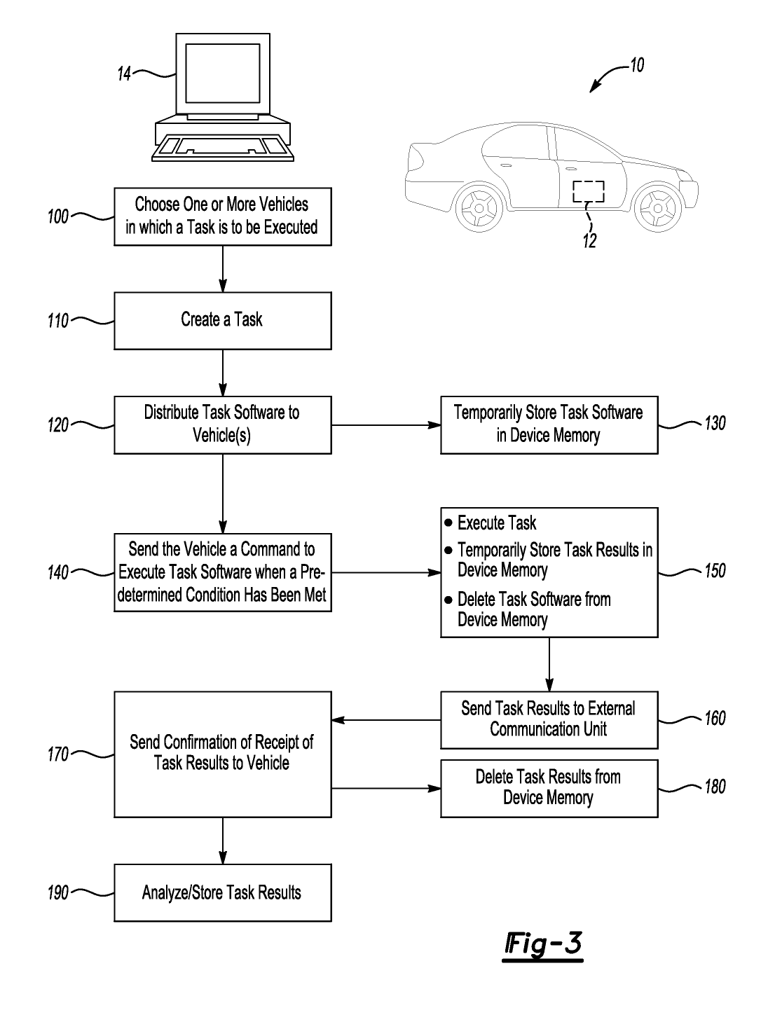

FIG. 3 shows a method according to an embodiment of the invention. The method comprises the step of a user of an external communication unit 14 choosing one or more vehicles 10 in which a task is to be executed (step 100) and creating a task (step 110). Data associated with the task is then distributed to the chosen vehicle(s) (step 120), i.e. a script or commands that will cause a vehicle-mounted device's controller 16 to execute that particular task is sent to the appropriate vehicle 10. The device 12 in each vehicle will then function as a programmable internal tester, that can be configured to perform tasks, such as ECU programming and/or vehicle performance monitoring and recording. The distributed commands may for example include an alert command instructing the vehicle-mounted device 12 to collect software from a file server (not shown). The device 12, on receiving/collecting the task software, temporarily stores it in its memory 24 (step 130). The external communication unit 14 in the illustrated embodiment is arranged to send a START command to cause the controller 16 to execute the task (step 140) together with or subsequently to receiving/collecting the task software. This START command may require that a particular condition, such as a particular vehicle operating condition or date or time, is met before the task is executed. Sending a vehicle a command to execute task software when a predetermined condition has been met is however optional.

Once any required condition has been met the device 12 executes the task, it temporarily stores the task results in its memory 24 and will then, at this (or a later point) in time, deletes the task software from its memory 24 (step 150).

A requirement that a pre-determined condition should be met before a task is executed can be incorporated when the task is created, whereby no subsequent command is necessary. Instead, the task will automatically be executed when the pre-determined condition is met.

The task results are sent to the external communication unit 14 (step 160) and once confirmation of their receipt has been sent from the external communication unit 14 (step 170) and received by the device 12, the task results are deleted from the device's memory 24 (step 180). The external communication unit 14 may be arranged to immediately or subsequently analyse and/or store the results in a database and/or update the task status in a database (step 190).

It should be noted that a particular task does not necessarily need to be completed before task results start being sent to the external communication unit 14. Task results may be sent to an external communication unit as soon as the results have been obtained for example. Furthermore, outgoing data need not necessarily be stored in the device's memory 24 at all, they may for example be sent directly to an external communication unit 14b. The memory 24 may be used solely for temporarily storing incoming data. Likewise, incoming data need not necessarily be stored in the device's memory 24 at all, they may for example cause a controller to directly execute at least one task. The memory 24 may then be used solely for temporarily storing outgoing data.

It should also be noted that the method steps shown in FIG. 3 may be repeated any number of times. For example, one or more new tasks can be distributed to a vehicle after the results of previously executed task have been received or analysed.

Such a method may be used to monitor a particular task or a set of tasks in a plurality of vehicles, such as a fleet of one hundred vehicles or more. Data associated with a task or tasks, such as updating the software in an ECU in each vehicle and/or performing fault detection, in the form of software or a script, may be sent to the plurality of vehicles simultaneously or sequentially. A transmitter in each vehicle may be arranged to inform an external communication unit as to whether each vehicle has executed the task. The method may then be used to monitor the percentage of vehicles in which the task has been executed.

Further modifications of the invention within the scope of the claims would be apparent to a skilled person.

While the best mode has been described in detail, those familiar with the art will recognize various alternative designs and embodiments within the scope of the following claims. Where one or more embodiments have been described as providing advantages or being preferred over other embodiments and/or over prior art in regard to one or more desired characteristics, one of ordinary skill in the art will recognize that compromises may be made among various features to achieve desired system attributes, which may depend on the specific application or implementation. These attributes include, but are not limited to: cost, strength, durability, life cycle cost, marketability, appearance, packaging, size, serviceability, weight, manufacturability, ease of assembly, etc. The embodiments described as being less desirable relative to other embodiments with respect to one or more characteristics are not outside the scope of the disclosure as claimed.

What is claimed:

1. Apparatus for managing at least one component of a vehicle comprising:
a controller executing a task comprising at least one of collecting information, downloading software, carrying out a measurement, performing a test, programming and performing diagnostics on the at least one component;
at least one of: a) a receiver receiving from an external communication unit remote to the vehicle incoming data associated with execution of the task, and b) a transmitter transmitting to the external communication unit outgoing data associated with execution of the task; and
a memory temporarily storing at least a portion of the incoming data and the outgoing data, and subsequently deleting at least some of the incoming data and the outgoing data when no longer needed because the controller has completed executing the task and/or communication with the external communication unit is complete.

2. The apparatus according to claim 1, wherein the controller executes the task only if a particular condition is met.

3. The apparatus according to claim 1, wherein the controller executes the task on receipt of at least one of a command from the external communication unit and a command from a user of the vehicle.

4. The apparatus according to claim 1, wherein the controller may be connected with an external tester and functioning of the controller is overridden when the external tester is connected to the vehicle.

5. The apparatus according to claim 1, wherein the outgoing data is deleted from the memory after the controller has received confirmation from the external communication unit that the external communication unit has received the outgoing data.

6. A apparatus for managing at least one component of a vehicle comprising:
a controller executing a task comprising at least one of collecting information, downloading software, carrying out a measurement, performing a test, programming and performing diagnostics on the at least one component; at least one external communication unit remote to the vehicle;
at least one of: a) a receiver receiving from the external communication unit remote to the vehicle incoming data associated with execution of the task, and b) a transmitter transmitting to the external communication unit outgoing data associated with execution of the task; and
a memory temporarily storing at least a portion of the incoming data and the outgoing data, and subsequently deleting at least some of the incoming data and the outgoing data when no longer needed because the controller has completed executing the task and/or communication with the external communication unit is complete.

7. The apparatus according to claim 6, wherein the controller executes the task only if a particular condition is met.

8. The apparatus according to claim 6, wherein the controller executes the task on receipt of at least one of a command from the external communication unit and a command from a user of the vehicle.

9. The apparatus according to claim 6, wherein the controller may be connected with an external tester and functioning of the controller is overridden when the external tester is connected to the vehicle.

10. The apparatus according to claim 6, wherein the outgoing data is deleted from the memory after the controller has received confirmation from the external communication unit that the external communication unit has received the outgoing data.

11. The apparatus according to claim 6, further comprising an off-board database for storing the outgoing data received by the external communication unit.

12. A method for managing at least one component of at least one vehicle comprising:
executing a task comprising at least one of collecting information, downloading software, carrying out a measurement, performing a test, programming and performing diagnostics on the at least one component;
performing a data transfer comprising at least one of: a) transmitting to an external communication unit outgoing data related to execution of the task; and b) receiving from the external communication unit incoming data related to execution of the task;
storing the incoming data and/or the outgoing data in a memory as necessary to complete the task execution step and the data transfer step; and
deleting from the memory at least some of the incoming data and the outgoing data when the execution step and/or the data transfer steps are completed.

13. The method according to claim 12, wherein the task execution step is carried out if a particular condition is met.

14. The method according to claim 12, wherein the task execution step is carried out upon receipt by the vehicle of a command from the external communication unit.

15. The method according to claim 12, wherein the step of deleting at least some of the data is accomplished after the external communication unit has transmitted a confirmation that the outgoing data has been received.

16. The method according to claim 12, wherein the outgoing data received by the external communication unit is analyzed and stored in an external database.
